(19) United States
(12) Patent Application Publication
(10) Pub. No.: US 2025/0236487 A1
(43) Pub. Date: Jul. 24, 2025

(54) LOAD MEASUREMENT ARRANGEMENT OF AN ELEVATOR AND A METHOD

(71) Applicant: KONE Corporation, Helsinki (FI)

(72) Inventors: Gabriela Roivainen, Helsinki (FI); Tapani Talonen, Helsinki (FI); Petri Alkula, Helsinki (FI); Lasse Hurri, Helsinki (FI); Ville Myyryläinen, Helsinki (FI)

(73) Assignee: KONE Corporation, Helsinki (FI)

(21) Appl. No.: 19/173,529

(22) Filed: Apr. 8, 2025

Related U.S. Application Data
(63) Continuation of application No. PCT/EP2022/080457, filed on Nov. 1, 2022.

(51) Int. Cl. B66B 1/34; B66B 7/06

(52) U.S. Cl. CPC B66B 1/3484; B66B 7/064

(57) ABSTRACT

A load measurement arrangement of an elevator comprising: a hoisting machinery (3) for driving an elevator car (2) in an elevator shaft (1); a hoisting machinery bed plate (11) supporting the hoisting machinery; and at least one load weighing sensor (20) located between the hoisting machinery (3) and the hoisting machinery bed plate (11). The load measurement arrangement comprises aligning means (25) for placing the at least one load weighing sensor (20) at a predefined point or at predefined points between the hoisting machinery (3) and the hoisting machinery bed plate (11). A method for elevator load measuring.

### FIELD OF THE INVENTION

The invention relates to load measurement of an elevator. The elevator is preferably an elevator for transporting passengers and/or goods.

### BACKGROUND OF THE INVENTION

Elevator car load information is needed for detecting an overload situation as well as for run-time torque control of an elevator hoisting machinery, for example.

An elevator system may have a load sensor, such as a strain gauge in connection with a car floor or a rope hitch for gathering the load information.

Document EP3705435A1 discloses a combined elevator vibration isolation and load measurement element. It has a vibration isolation pad and a load sensor arrangement. An elastic material layer has been attached to one surface of the vibration isolation pad. Load acting on the combined elevator vibration isolation and load measurement element can be measured with the load sensor arrangement as a function of the compression of the elastic material layer. The combined elevator vibration isolation and load measurement element may be fitted between a hoisting machinery and machinery bed plate. The bed plate may be fixed to a guide rail of an elevator system. Document EP3705441A1 shows use of such combined vibration isolation and load measurement element for car stalling detection.

There is a need for accurate load measurement of an elevator.

### SUMMARY OF THE INVENTION

An object of the present invention is to introduce an improved load measurement arrangement of an elevator and an improved method for elevator load measuring. The invention provides solutions relating to problems associated with accuracy in elevator load measuring.

The load measurement arrangement of an elevator according to the invention is defined in independent claim 1.

The load measurement arrangement of an elevator comprises a hoisting machinery for driving an elevator car in an elevator shaft; a hoisting machinery bed plate supporting the hoisting machinery; and at least one load weighing sensor located between the hoisting machinery and the hoisting machinery bed plate.

The load measurement arrangement comprises aligning means for placing the at least one load weighing sensor at a predefined point or at predefined points between the hoisting machinery and hoisting machinery bed plate.

Preferable further details of the invention are introduced in the following, which further details can be combined individually or in any combination.

According to an embodiment the aligning means comprises at least one recess for the at least one load weighing sensor on at least one of the countersurfaces of the hoisting machinery and the hoisting machinery bed plate.

According to an embodiment at least two load weighing sensors are located between the hoisting machinery and the hoisting machinery bed plate.

According to an embodiment the load measurement arrangement comprises two load weighing sensors and the distance between said two sensors is substantially one third of the width of the hoisting machinery bed plate.

According to an embodiment the load weighing sensors are placed vertically under a traction sheave comprised by the hoisting machinery.

According to an embodiment the at least one load weighing sensor is placed vertically under a load line of ropes which are guided over the traction sheave comprised by the hoisting machinery.

According to an embodiment two load weighing sensors are placed horizontally at a predefined distance from each other such that they are disposed symmetrically with respect to the hoisting machinery bed plate.

According to an embodiment the arrangement comprises an adapter board having one or more load weighing sensors at predefined points of the board.

According to an embodiment the aligning means comprises an adapter board having one or more load weighing sensors at predefined points of the board.

According to an embodiment the adapted board is configured to be fitted between the hoisting machinery and the hoisting machinery bed plate.

According to an embodiment the adapter board comprises at least one structural element, such as one or more holes or pins or clips, for aligning the adapter board at a predefined location between the hoisting machinery and the hoisting machinery bed plate.

According to an embodiment the at least one load weighing sensor comprises a sensor selected from a group including: a capacitive sensor, a strain gauge, a load cell, a compression measurement of an elastic element, and a hydraulic pressure sensor.

According to an embodiment an elastic vibration damping element is fitted between the hoisting machinery and the hoisting machinery bed plate and in connection with said at least one load weighing sensor.

According to an embodiment the hoisting machinery comprises a motor, a traction sheave and at least one hoisting machinery brake.

According to an embodiment the elevator comprises:
one or more suspension ropes; and a counterweight;
the car and the counterweight being suspended by said one or more ropes which are guided over a traction sheave for moving the car vertically in the elevator shaft.

The method for elevator load measuring according to the invention is defined in independent claim 16.

The method for elevator load measuring, wherein the elevator comprises a hoisting machinery for driving an elevator car in an elevator shaft; a hoisting machinery bed plate supporting the hoisting machinery;
comprises measuring load of the elevator by at least one load weighing sensor located between the hoisting machinery and the hoisting machinery bed plate.

The method comprises providing an aligning means for the at least one load weighing sensor, and placing by the aligning means the at least one load weighing sensor at a predefined point or at predefined points between the hoisting machinery and hoisting machinery bed plate.

Preferable further details of the invention are introduced in the following, which further details can be combined individually or in any combination.

According to an embodiment the method comprises placing two load weighing sensors at a distance between said two sensors, wherein distance is substantially one third of the width of the hoisting machinery bed plate.

According to an embodiment the method comprises placing the at least one load weighing sensor vertically under a load line of ropes which are guided over the traction sheave comprised by the hoisting machinery.

According to an embodiment the method comprises placing two load weighing sensors horizontally at a predefined distance from each other such that they are disposed symmetrically with respect to the hoisting machinery bed plate.

According to an embodiment the method comprises fitting an elastic vibration damping element between the hoisting machinery and the hoisting machinery bed plate and in connection with said at least one load weighing sensor.

Further embodiments and advantages of the invention are described hereinafter.

Generally, the invention represents using one or more load weighing sensors fitted in connection with an elevator hoisting machinery. The load measurement arrangement comprises aligning means for placing at least one load weighing sensor at a predefined point or at predefined points between the hoisting machinery and a hoisting machinery bed plate.

According to an embodiment said aligning means comprises at least one recess for said at least one load weighing sensor on at least one of the countersurfaces of the hoisting machinery and the hoisting machinery bed plate.

Possible load weighing sensor types include capacitive sensors, strain gauges/load cells, compression measurement of an elastic element, and hydraulic pressure sensors.

Additionally or alternatively, said measurement arrangement may comprise an adapter board having one or more load weighing sensors at predefined points of the board, wherein the adapted board is fitted between the hoisting machinery and the hoisting machinery bed plate. The adapter board may comprise a structural element, such as one or more holes or pins or clips for aligning the adapter board at a predefined location between the hoisting machinery and the hoisting machinery bed plate.

The inventors have found out, that placing the load weighing sensors at predefined optimal points between the elevator hoisting machinery and a bed plate of the hoisting machinery provides an improvement in load measurement accuracy. Such improvement in the measurement accuracy may be achieved in various operational situations of the elevator, and irrespective of car position or elevator balancing. This optimal location is important for the measurement accuracy.

This can mean that load measurement accuracy is good enough for overload detection and elevator ride comfort level as standardized for elevators. Thanks to the invention no extra load sensor(s) in the car floor or rope hitch is/are needed. The solution simplifies installation work as well and facilitates maintenance of the elevator system. According to dynamic analysis the solution works well even in special operational situations as in buffer run case when the car or the counterweight hits the buffer. The same holds true for other special situations as well, such as when safety gear of an elevator car operates in downwards direction and counterweight jumps in upwards direction.

By means of the invention it is possible to detect also other critical operational conditions than an overload situation. For example, because of improved measurement accuracy it is possible to reliably detect an entrapment situation, if a person is entrapped because of an operational anomaly and needs to be rescued from an elevator car.

One advantage of the invention is that the measurement arrangement provides direct information of the load acting on the traction sheave of the elevator hoisting machinery. This information may be useful for detecting also other parameters than car load, i.e. the load received inside an elevator car. Using at least two independent sensors may provide information of load distribution within the area between the machinery and the bed plate. This distribution information is characteristic of load distribution at different sides of the traction sheave. Thus the load distribution information may be useful e.g. for identifying whether a stalling situation was caused by a jammed elevator car or a jammed counterweight. By a stalling situation is meant a dangerous situation wherein the counterweight and/or the elevator car gets jammed while the car or the counterweight is moving upwards, causing risk of hazardous situation such as derailment or sudden drop of elevator masses in elevator shaft.

As the load distribution at different sides of the traction sheave changes when the elevator car is moving, the load distribution information may be useful for determining elevator car position in elevator shaft as well. It may be especially useful for overlay cases, wherein there is no direct positioning information of the elevator car available. Such an overlay case may be a third-party elevator under a maintenance contract of a separate elevator maintenance company.

By means of the invention it may also be possible to detect condition of elevator guide rails, from measurable effect of variable guide rail friction on moving elevator masses. It may be also possible to detect a jump load, i.e. a situation wherein tension of the hoisting ropes on the traction sheave rapidly decreases, as the load “jumps”, for example in an emergency stopping situation.

### BRIEF DESCRIPTION OF THE DRAWINGS

The invention will in the following be described in greater detail by means of preferred embodiments with reference to the attached drawings, in which:

FIG. 1 shows a side view of a first elevator,

FIG. 2 shows a side view of a second elevator,

FIG. 3 shows a partial view of a load measurement arrangement of an elevator,

FIG. 4 shows an embodiment of aligning means for placing at least one load weighing sensor between the hoisting machinery and a hoisting machinery bed plate, and

FIG. 5 shows an embodiment of the aligning means.

### DETAILED DESCRIPTION

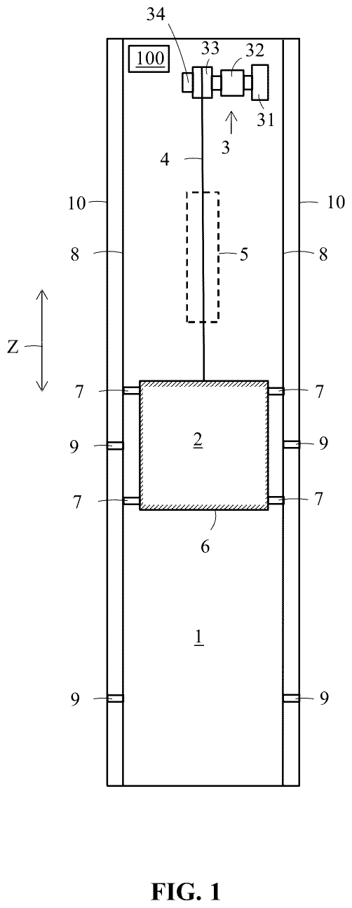

FIG. 1 shows a side view of a first elevator.

The elevator may comprise a car 2, an elevator shaft 1, a hoisting machinery 3, hoisting ropes 4, and a counterweight 5. A separate or an integrated car frame 6 may surround the car 2.

The hoisting machinery 3 may be positioned in the shaft 1. The hoisting machinery may comprise a drive 31, an electric motor 32, a traction sheave 33, and a machinery brake 34. The hoisting machinery 3 may move the car 2 in a vertical direction Z upwards and downwards in the vertically extending elevator shaft 1. The machinery brake 34 may stop the rotation of the traction sheave 33 and thereby the movement of the elevator car 2.

In FIG. 1, the car 2 is connected by the ropes 4 via the traction sheave 33 to the counterweight 5. The car and the counterweight are suspended by one or more ropes 4 which are guided over the traction sheave 33 for moving the car 2 vertically in the shaft 1.

In FIG. 1, the car 2 is further supported with guide members 7 at guide rails 8 extending in the vertical direction in the shaft. The guide rails may be attached with fastening brackets 9 to the side wall structures 10 in the shaft. The guide members 7 ensure the vertical movement of the car 2 when the car moves upwards and downwards in the shaft 1. The counterweight 5 may be supported in a corresponding way on guide rails that are attached to the wall structure 10 of the shaft 1.

The car 2 may transport people and/or goods between the landings in the building. The elevator shaft 1 may be formed so that the wall structure 10 is formed of solid walls or so that the wall structure 10 is formed of an open steel structure.

The roping ratio is 1:1 in this first elevator. When the electric motor 32 lifts or lowers the car 2 in this first elevator by X meters, then X meters of lifting rope 4 passes over the traction sheave 33.

A drive unit 100, for example a frequency converter, may be disposed close to the hoisting machinery 3.

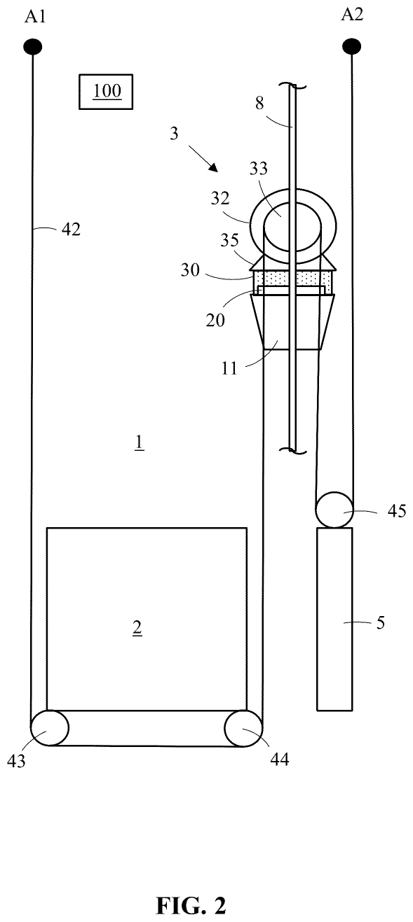

FIG. 2 shows a side view of a second elevator.

This second elevator differs from the first elevator shown in FIG. 1 in the roping ratio. The roping ratio in this second elevator is 2:1 compared to the roping ratio 1:1 in the first elevator shown in FIG. 1. When the electric motor 32 lifts or lowers the car 2 in this second elevator by X meters, then 2X meters of hoisting rope 42 passes over the traction sheave 33.

Both ends of the hoisting rope 42 are fixed in fixing points A1, A2 relative to the shaft 1 in an upper end portion of the shaft 1. The hoisting rope 42 passes from a first fixing point A1 vertically downwards in the shaft 1 towards the lower end of the car 2. The hoisting rope 42 is then turned on a first deflection roll 43 positioned below the car 2 into a horizontal direction. The hoisting rope 42 passes then in the horizontal direction to a second deflection roll 44 positioned below the car 2 at an opposite side of the car 2 in relation to the first deflection roll 43. The car 2 is supported on the first deflection roll 43 and on the second deflection roll 44. The hoisting rope 42 passes after the second deflection roll 44 again vertically upwards in the shaft 2 towards the traction sheave 33. The hoisting rope 42 is then again turned on the traction sheave 33 into a vertically downwards directed direction in the shaft 2 towards a third deflection roll 45. The counterweight 5 is supported on the third deflection roll 45. The hoisting rope 42 passes then after the third deflection roll 45 again vertically upwards in the shaft 1 to the second fixing point A2. Rotation of the traction sheave 33 in a clockwise direction moves the car 1 upwards, whereby the counterweight 5 moves downwards and vice a versa. The friction between the hoisting rope 42 and the traction sheave 33 eliminates slipping of the hoisting rope 42 on the traction sheave 33 in normal operational conditions.

The electric motor 32 in the hoisting machinery 3 may comprise a motor frame 35 for supporting the hoisting machinery 3 on a hoisting machinery bed plate 11.

At least one load weighing sensor 20 is located between the hoisting machinery 3 and the hoisting machinery bed plate 11. A vibration isolation pad 30 may be positioned between the motor frame 35 and the hoisting machinery bed plate 11. The hoisting machinery bed plate 11 may be supported on a guide rail 8 in the shaft 1. The hoisting machinery 3 could be supported on the guide rail 8 in any height position along the guide rail 8. The traction sheave 33 and the electric motor 32 could also be separated. The traction sheave 33 could be supported on the guide rail 8 in the shaft 1 and the electric motor 32 could be positioned e.g. at the bottom of the pit in the shaft 1. A power transmission would thus be needed between the traction sheave 33 and the electric motor 32.

A drive unit 100, for example a frequency converter, may be disposed close to the hoisting machinery 3.

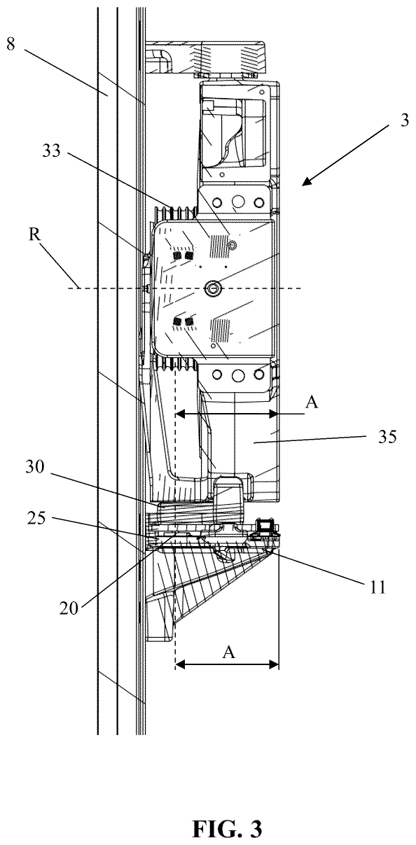

FIG. 3 shows a partial view of a load measurement arrangement of an elevator.

According to an embodiment, the hoisting machinery 3 is located on top of a hoisting machinery bed plate 11. Preferably the bed plate 11 is fixed to a guide rail 8 of an elevator. Another fixing point to the guide rail 8 is in top portion of the hoisting machinery 3. In FIG. 3 the hoisting machinery 3 is substantially flat or disc-shaped, and it is located between the guide rail 8 and an elevator shaft wall 10, preferably in top portion of the shaft 1. The hoisting machinery 3 has a stationary body 35 supported on the bed plate 11, which body 35 contains a stator of the hoisting motor. The hoisting machinery 3 also has a rotating rotor, with an integrated traction sheave 33. The rotor and the stator are arranged concentrically around the rotating axis R of the hoisting machinery 3.

According to an embodiment there is at least one load weighing sensor 20 placed vertically under the traction sheave 33. According to an embodiment there are two load weighing sensors 20 placed vertically under the traction sheave 33. According to an embodiment the load weighing sensors 20 are placed vertically under the ropes 4, 42 load line A, in particular the vertical line located in the middle of the traction sheave 33 grooves.

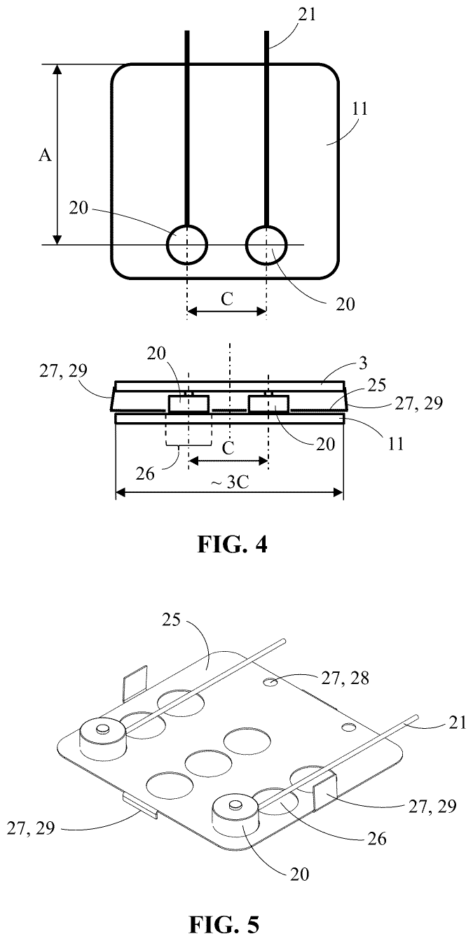

According to an embodiment there are two load weighing sensors 20 placed horizontally at a predefined distance C from each other such that they are disposed symmetrically with respect to the hoisting machinery bed plate 11 as shown in FIG. 4.

FIG. 4 shows an embodiment of the aligning means 25 comprised by the load measurement arrangement for placing at least one load weighing sensor 20 at a predefined point or at predefined points between the hoisting machinery 3 and the hoisting machinery bed plate 11.

Possible load weighing sensor 20 types include capacitive sensors, strain gauges/load cells, compression measurement of an elastic element, and hydraulic pressure sensors.

FIG. 5 shows an embodiment of the aligning means 25 comprising at least one recess 26 for said at least one load weighing sensor 20 on at least one of the countersurfaces of the hoisting machinery 3 and the hoisting machinery bed plate 11. Preferably said at least one recess 26 is configured to receive said at least one load weighing sensor 20 for locating said sensors at predefined points of the board.

Additionally or alternatively, said measurement arrangement may comprise an adapter board 25 having one or more load weighing sensors 20 at predefined points of the board. According to an embodiment the aligning means 25 comprises an adapter board having one or more load weighing sensors at predefined points of the board. According to an embodiment the aligning means 25 comprises at least one recess 26 for said at least one load weighing sensor 20 on at least one of the countersurfaces of the hoisting machinery 3 and the hoisting machinery bed plate 11.

According to an embodiment the adapter board is fitted in measurement use between the hoisting machinery 3 and the hoisting machinery bed plate 11. According to an embodiment the adapter board comprises at least one structural element 27, such as one or more holes 28 or pins or clips 29, for aligning the adapter board at a predefined location between the hoisting machinery 3 and the hoisting machinery bed plate 11.

According to an embodiment the adapter board 25 comprises at least one structural element extending to the direction of the hoisting machinery 3 when inserted between the hoisting machinery 3 and the hoisting machinery bed plate 11. According to an embodiment the adapter board 25 comprises at least one structural element extending to the direction of the hoisting machinery bed plate 11 when inserted between the hoisting machinery 3 and the hoisting machinery bed plate 11. The adapter board preferably has a planar shape.

According to an embodiment the adapter board 25 comprises an array of recesses 26 adapted to predefined sizes of available hoisting machineries 3 and respective hoisting machinery bed plates 11 having predefined rope load lines A located in the middle of the traction sheave 33 grooves.

According to an embodiment the load measurement arrangement comprises two load weighing sensors 20 and the distance C between said two sensors 20 is substantially one third of the width 3C of the bed plate 11, as shown in FIG. 4. There may be an elastic vibration damping element 30 fitted between the hoisting machinery 3 and the bed plate 11 and in connection with said load weighing sensors 20.

One way to understand the advantageous effect of use of at least two sensors for the load detection is a “three-leg chair” analogy. When only one of the three legs is a sensor, there will be problem with force impacts, and the situation is unstable. Whereas when two of the legs are sensors, and the third leg consists, e.g., optionally of a passive support structure, a more stable situation and/or improved measurement accuracy is achieved. The third leg must not comprise a sensor. The bed plate 11 optionally comprises a passive support structure such as an outstanding leg, preferably forming the third leg of the above analogy with three legs.

A drive unit 100, for example a frequency converter, may be disposed close to the hoisting machinery 3. According to an embodiment drive unit is disposed at the same location with the hoisting machinery 3 in the elevator shaft 1. This way there will be no substantial voltage drop in the one load weighing sensor 20 cables 21 between the drive unit 100 and the hoisting machinery 3 in the same way as if sensors located in connection with an elevator car or a rope hitch had to be wired to the drive unit. Thus it is possible to achieve a good measurement accuracy with more simple and cost-effective measurement electronics.

The use of the invention is not limited to the embodiments disclosed in the figures. The invention can be used in any type of elevator e.g. an elevator comprising a machine room or lacking a machine room, an elevator comprising a counterweight or lacking a counterweight. The counterweight could be positioned on either side wall or on both side walls or on the back wall of the elevator shaft. The drive, the motor, the traction sheave, and the machine brake could be positioned in a machine room or somewhere in the elevator shaft. The elevator car guide rails could be positioned on opposite side walls of the shaft or on a back wall of the shaft.

It will be obvious to a person skilled in the art that, as the technology advances, the inventive concept can be implemented in various ways. The invention and its embodiments are not limited to the examples described above but may vary within the scope of the claims.

1. A load measurement arrangement of an elevator comprising
a hoisting machinery for driving an elevator car in an elevator shaft;
a hoisting machinery bed plate supporting the hoisting machinery;
at least one load weighing sensor located between the hoisting machinery and the hoisting machinery bed plate;
wherein the load measurement arrangement comprises aligning means for placing the at least one load weighing sensor at a predefined point or at predefined points between the hoisting machinery and the hoisting machinery bed plate.

2. The arrangement according to claim 1, wherein the aligning means comprises at least one recess for the at least one load weighing sensor on at least one of the countersurfaces of the hoisting machinery and the hoisting machinery bed plate.

3. The arrangement according to claim 1, wherein at least two load weighing sensors are located between the hoisting machinery and the hoisting machinery bed plate.

4. The arrangement according to claim 1, wherein the load measurement arrangement comprises two load weighing sensors and the distance (C) between said two sensors is substantially one third of the width (3C) of the hoisting machinery bed plate.

5. The arrangement according to claim 1, wherein the load weighing sensors are placed vertically under a traction sheave comprised by the hoisting machinery.

6. The arrangement according to claim 1, wherein the at least one load weighing sensor is placed vertically under a load line (A) of ropes which are guided over the traction sheave comprised by the hoisting machinery.

7. The arrangement according to claim 1, wherein two load weighing sensors are placed horizontally at a predefined distance (C) from each other such that they are disposed symmetrically with respect to the hoisting machinery bed plate.

8. The arrangement according to claim 1, wherein the arrangement comprises an adapter board having one or more load weighing sensors at predefined points of the board.

9. The arrangement according to claim 1, wherein the aligning means comprises an adapter board having one or more load weighing sensors at predefined points of the board.

10. The arrangement according to claim 8, wherein the adapter board is configured to be fitted between the hoisting machinery and the hoisting machinery bed plate.

11. The arrangement according to claim 8, wherein the adapter board comprises at least one structural element, such as one or more holes or pins or clips, for aligning the adapter board at a predefined location between the hoisting machinery and the hoisting machinery bed plate.

12. The arrangement according to claim 1, wherein the at least one load weighing sensor comprises a sensor selected from a group including: a capacitive sensor, a strain gauge, a load cell, a compression measurement of an elastic element, and a hydraulic pressure sensor.

13. The arrangement according to claim 1, wherein an elastic vibration damping element is fitted between the hoisting machinery and the hoisting machinery bed plate and in connection with said at least one load weighing sensor.

14. The arrangement according to claim 1, wherein the hoisting machinery comprises a motor, a traction sheave and at least one hoisting machinery brake.

15. The arrangement according to claim 1, wherein the elevator comprises:
one or more suspension ropes; and a counterweight;
the car and the counterweight being suspended by said one or more ropes which are guided over a traction sheave for moving the car vertically in the elevator shaft.

16. A method for elevator load measuring,
the elevator comprising a hoisting machinery for driving an elevator car in an elevator shaft; a hoisting machinery bed plate supporting the hoisting machinery;
the method comprising measuring load of the elevator by at least one load weighing sensor located between the hoisting machinery and the hoisting machinery bed plate;
wherein
providing an aligning means for the at least one load weighing sensor, and
placing by the aligning means the at least one load weighing sensor at a predefined point or at predefined points between the hoisting machinery and hoisting machinery bed plate.

17. The method according to claim 16, wherein placing two load weighing sensors at a distance (C) between said two sensors, wherein distance (C) is substantially one third of the width (3C) of the hoisting machinery bed plate.

18. The method according to claim 16, wherein placing the at least one load weighing sensor vertically under a load line (A) of ropes which are guided over the traction sheave comprised by the hoisting machinery.

19. The method according to claim 16, wherein placing two load weighing sensors horizontally at a predefined distance (C) from each other such that they are disposed symmetrically with respect to the hoisting machinery bed plate.

20. The method according to claim 16, wherein fitting an elastic vibration damping element between the hoisting machinery and the hoisting machinery bed plate and in connection with said at least one load weighing sensor.
